(19) United States
(12) Patent Application Publication
(10) Pub. No.: US 2026/0015699 A1
(43) Pub. Date: Jan. 15, 2026

(54) NON-ORIENTED ELECTRICAL STEEL PLATE AND MANUFACTURING METHOD THEREFOR

(71) Applicant: Baoshan Iron & Steel Co., Ltd., Shanghai (CN)

(72) Inventors: Feng Zhang, Shanghai (CN); Xuejun Lv, Shanghai (CN); Bo Wang, Shanghai (CN); Guobao Li, Shanghai (CN)

(21) Appl. No.: 18/994,679

(22) PCT Filed: Jul. 20, 2023
(86) PCT No.: PCT/CN2023/108442

§ 371 Date: Jan. 15, 2025

(30) Foreign Application Priority Data
Jul. 20, 2022 (CN) 202210861072.X

(51) Int. Cl. C22C 38/02; C21D 6/00; C21D 8/02; C21D 9/46; C22C 38/00; C22C 38/04; C22C 38/06; C22C 38/18

(52) U.S. Cl. CPC C22C 38/02; C21D 6/008; C21D 8/0205; C21D 8/0226; C21D 8/0236; C21D 8/0273; C21D 8/0278; C21D 9/46; C22C 38/004; C22C 38/04; C22C 38/06; C22C 38/18

(57) ABSTRACT

The present invention discloses a non-oriented electrical steel plate, wherein the steel plate comprises, in addition to Fe and inevitable impurities, the following chemical elements in percentage by mass: 0<C<0.01%, 0<Si≤4.5%, Mn: 0.05˜2.0%, AI: 0.1˜2.0%, Cr: 0.005˜0.2%; the mass percentage ratio of Al to Cr satisfies: 10≤Al/Cr≤80. In addition, the present invention also discloses a method for manufacturing the above-mentioned non-oriented electrical steel plate, comprising the following steps: (1) smelting and casting to obtain a continuous casting slab; (2) heating and rolling to obtain a hot-rolled steel plate, wherein when the continuous casting slab is heated in a heating furnace and a temperature is raised to 1020° C. or more, a heating rate is controlled to be 0.8˜2.0° C./min; and a soaking time of the continuous casting slab in the heating furnace/a time of the continuous casting slab in the heating furnace is controlled to be 0.10-0.25h; (3) pickling the hot-rolled steel plate; (4) cold-rolling the hot-rolled steel plate to obtain a cold-rolled steel plate; (5) continuous annealing the cold-rolled steel plate to obtain a finished steel plate; and (6) coating a surface of the finished steel plate.

### TECHNICAL FIELD

The present invention relates to a steel plate and a manufacturing method therefor, in particular to a non-oriented electrical steel plate and a manufacturing method therefor.

### BACKGROUND

In recent years, many steel smelting plants have increasingly higher requirements for the purity of non-oriented electrical steel plates when practically producing non-oriented electrical steel plates due to the user market's demand for excellent electromagnetic properties of steel plates.

In the current prior art, in order to obtain non-oriental electrical steel plates with high purity, it is usually hoped that the contents of the harmful elements nitrogen and sulfur in the steel are as low as possible, especially the nitrogen content is as low as possible. This is because that the nitrogen and sulfur elements in the steel will eventually be converted into nitride and sulfide inclusions remaining in the steel, which eventually inhibit the growth of grain size and the development of favorable texture in the finished steel plate. However, it should be noted that excessive reduction of the nitrogen and sulfur contents in steel will also greatly increase the difficulty of steel production. Therefore, at present, researchers have conducted a lot of research and proposed various new solutions in the hope of effectively reducing nitride inclusions in steel without excessively reducing the nitrogen content.

For example: Japanese patent document with the publication number of 06-128618, published on May 10, 1994, entitled “Method for manufacturing electrical steel plate with low inclusion content” discloses a method for manufacturing electrical steel plate with low inclusion content. The method requires that after the converter smelting is completed, FeSi is used as a pre-deoxidizer to pre-deoxidize the molten steel, and the free oxygen content in the steel is controlled between 300 and 500 ppm, and the alkalinity in the ladle top slag is controlled to be 2˜10; then, the RH degassing device requires three stages of refining treatment, and the free oxygen content in the steel is required to be controlled to be 400 ppm or less before final deoxidation using FeSi, and six or more cycles are required after the final deoxidation of the molten steel. For another example, the Chinese patent document with the publication number of CN101914730A, published on Dec. 15, 2010, entitled “Vanadium-containing titanium-containing cold-rolled non-oriented electrical steel and a manufacturing method therefor” discloses a vanadium-containing titanium-containing cold-rolled non-oriented electrical steel and a manufacturing method therefor, which can effectively reduce the precipitation of fine dispersed vanadium-titanium carbonitrides through reasonable design of the composition. In this technical solution, the manufacturing method adopted is to control the temperature in the heating step to 1140˜1170° C., the start rolling temperature of the finishing rolling to ≥1030° C., the final rolling temperature to 890-930° C., and the temperature in the coiling step to ≥650° C., so as to further suppress the formation and influence of vanadium-titanium precipitates from the perspective of thermodynamics and kinetics through design of the process. By suppressing the adverse effects of vanadium and titanium, the technical solution can effectively produce vanadium-containing and titanium-containing non-oriented electrical steel that meet the requirements for electromagnetic performance, which expands the source range of raw materials for smelting non-oriented electrical steel, especially the utilization of recycled steel, and can effectively reduce the production cost of non-oriented electrical steel.

Based on this, different from the above-mentioned existing technical solutions, the inventors design and expect to obtain a new non-oriented electrical steel plate with a low nitride inclusion content and a manufacturing method thereof, so as to improve the purity of non-oriented silicon steel and thus meet the needs of the market and users.

### SUMMARY

One of the objects of the present invention is to provide a non-oriented electrical steel plate with a low nitride inclusion content, which aims to improve the purity of the non-oriented electrical steel plate to solve the problem of inclusion control effect. The steel plate can effectively meet the needs of the market and users and has good promotion and application prospects.

In order to achieve the above-mentioned objective, the present invention provides a non-oriented electrical steel plate, the steel comprises, in addition to Fe and inevitable impurities, the following chemical elements in percentage by mass:

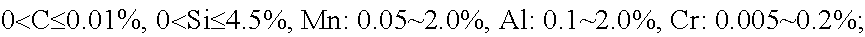

a mass percentage ratio of Al and Cr satisfy: 10≤Al/Cr≤80, preferably 13.9≤Al/Cr≤49. Preferably, the non-oriented electrical steel plate according to the present invention comprises the following chemical elements in percentage by mass:
0≤C≤0.01%, 0<Si≤4.5%, Mn: 0.05˜2.0%, Al: 0.1˜2.0%, Cr: 0.005˜0.2%, the balance being Fe and inevitable impurities;
the mass percentage ratio of Al to Cr satisfies: 10≤Al/Cr≤80, preferably 13.9≤Al/Cr≤49.

In the non-oriented electrical steel according to the present invention, design principles of the chemical elements are as follows:

C: The element C can strongly hinder the growth of the grains of the finished strip steel, and the element C is easy to combine with Nb, V, Ti, etc. to form fine precipitates, thereby causing increased losses and producing magnetic aging. Therefore, considering the influence of C on the properties of steel, in the non-oriented electrical steel plate according to the present invention, the content of C must be strictly controlled, and the mass percentage content of C is specifically controlled to be 0<C≤0.01%.

Si: The element Si can increase the resistivity of the material and effectively reduce the iron loss of the steel. It should be noted that the Si content in the steel should not be too high. When the Si content in the steel is high than 4.5%, it will significantly reduce the magnetic induction of the steel and lead to strip breaking in cold rolling. Therefore, in the non-oriented electrical steel plate according to the present invention, the content of Si must be strictly controlled, and the mass percentage content of Si is specifically controlled to satisfy: 0<Si≤4.5%.

Mn: Mn and S can combine to form MnS, which can effectively reduce the damage to the magnetic properties of the steel. When the Mn content in steel is less than 0.05%, the S fixation effect of the Mn element is poor, and when the Mn content in steel is higher than 2.0%, the manufacturing cost of steel will be greatly increased. Therefore, in the non-oriented electrical steel plate according to the present invention, the mass percentage content of Mn is controlled between 0.05 and 2.0%.

Al: Al is an important deoxidizing element. When the Al content in steel is less than 0.1%, it will fail to achieve good deoxidation effect, and when the Al content in steel exceeds 2.0%, it will lead to casting difficulties in continuous casting and deteriorates the workability of cold rolling. Based on this, in order to exert the beneficial effect of Al, in the non-oriented electrical steel plate according to the present invention, the mass percentage content of Al is controlled between 0.1 and 2.0%, preferably between 0.47 and 2.0%.

Cr: Cr element can combine with N to generate Cr₂N, thereby effectively fixing N. When the Cr content in the steel is less than 0.005%, the N fixing effect of Cr will deteriorate, and when the Cr content in the steel exceeds 0.2%, it will cause abnormal grain refinement. Therefore, in order to exert the beneficial effect of Cr, in the non-oriented electrical steel plate according to the present invention, the mass percentage content of Cr in the steel must be strictly controlled, and the mass percentage content of Cr is specifically controlled between 0.005 and 0.2%.

Certainly, in some preferred embodiments, in order to obtain better implementing effects, the mass percentage content of Cr can be further preferably controlled between 0.01 and 0.12%.

Accordingly, while controlling the mass percentage content of a single chemical element, the present invention further controls the mass percentage ratio of Al to Cr in the steel to satisfy: 10≤Al/Cr≤80, preferably 13.9≤Al/Cr≤49.

In the present invention, the mass percentage ratio of Al to Cr in the steel is controlled to satisfy: 10≤Al/Cr≤80, which can ensure that AlN and Cr₂N inclusions of appropriate quantity and proportion are formed during the solidification in casting of molten steel and the hot rolling of continuous casting slabs, thereby achieving the control requirement of 0.8 [AlN]/([AlN]+ [Cr₂N])≤0.99. This is because, during the solidification in casting of molten steel, Al preferentially combines with N to form AlN inclusions. Generally, the lower the contents of Al and N and the lower the temperature of the molten steel, the later the precipitation of AlN inclusions, the smaller the size of AlN inclusions and the greater the harm of AlN inclusions. In this case, by adding an appropriate amount of Cr to the steel, Cr together with Al can combine with N at the end of continuous casting to form coarse-sized and small-quantity Cr₂N inclusions in advance, thereby greatly reducing the harm of AlN precipitation in the later stage. Therefore, in order to ensure the quality of steel, 10≤Al/Cr≤80, preferably 13.9≤Al/Cr≤49 is controlled herein.

When the Al/Cr ratio in the steel is more than 80, it means that the proportion of Cr in the steel is too law; thereby the formation time of Cr₂N will be significantly delayed, and the size of Cr₂N will be small when it is precipitated and the harm of Cr₂N will be great. When the Al/Cr ratio in the steel is lower than 10, it means that the content of Cr in the steel is too high. In this case, the precipitation time of AlN is significantly delayed, and the AlN formed has small quantity and size, and great harm. At the same time, the formation time of Cr₂N is significantly advanced, and the quantity of Cr₂N will increase significantly when it is precipitated. Due to the low melting point of Cr₂N, when the quantity of Cr₂N is large, the Cr₂N will re-solubilize during hot rolling process, and then precipitate again during the finish rolling and coiling processes, resulting in a sharp reduction in size, a significantly larger amount, and greater harm. Therefore, [Al]/[Cr] in steel must be strictly limited.

Preferably, in the non-oriented electrical steel plate according to the present invention, wherein among the inevitable impurities, P≤0.2%, S≤0.005%, N≤0.005%, O≤0.005%. In the non-oriented electrical steel according to the present invention, P element, S element, N element and O element are all impurity elements in the non-oriented electrical steel plate, which are impurity elements introduced from the steel raw materials and auxiliary materials or the production process. Under the condition that technical conditions permit, in order to obtain a steel with better performance and better quality, the content of impurity elements in the steel should be reduced as much as possible.

P: When the mass percentage of P in steel exceeds 0.2%, it is easy to cause the occurrence of cold brittleness and reduce the manufacturability during the cold rolling process. Therefore, in the non-oriented electrical steel plate according to the present invention, the mass percentage of P is controlled to be: P≤0.2%.

S: When the mass percentage of S in steel exceeds 0.005%, the quantity of harmful inclusions such as MnS and Cu₂S increases greatly, thereby causing the iron loss of steel to deteriorate. Therefore, in the non-oriented electrical steel plate according to the present invention, the mass percentage of S is controlled to be: S≤0.005%.

N: When the mass percentage of N in steel exceeds 0.005%, the precipitates of Nb, V, Ti, Al, etc. with N increases greatly, which strongly hinders the growth of grains, thereby deteriorating the magnetic properties of the steel. Therefore, in the non-oriented electrical steel plate according to the present invention, the mass percentage of N is controlled to be: N≤0.005%.

O: When the mass percentage of O in steel exceeds 0.005%, the quantity of oxide inclusions increases greatly, which is not conducive to adjusting the proportion of favorable inclusions and deteriorates the magnetic properties of steel. Therefore, in the non-oriented electrical steel plate according to the present invention, the mass percentage of O is controlled to be: 0≤0.005%.

Preferably, in the non-oriented electrical steel plate according to the present invention, the content of Cr is 0.01˜0.12%.

Preferably, in the non-oriented electrical steel plate according to the present invention, the nitride inclusions in the steel are mainly single Cr₂N and/or AlN composite inclusions encapsulated with Cr₂N.

Preferably, in the non-oriented electrical steel plate according to the present invention, the volume ratio of nitride inclusions AlN and Cr₂N satisfies:

$$0.8 \leq [ AlN ] / ( [ AlN ] + [ {Cr}_{2} N ] ) \leq 0.99 .$$

Preferably, in the non-oriented electrical steel plate according to the present invention, the quantity of nitride inclusions is ≤2.5×10⁷/mm³.

Preferably, in the non-oriented electrical steel plate according to the present invention, nitride inclusions with a size of 0.2 to 1.0 μm account for 50% or more of all nitride inclusions by volume percentage.

Accordingly, another object of the present invention is to provide a method for manufacturing the above-mentioned non-oriented electrical steel plate, the method is simple and feasible, by which a non-oriented electrical steel plate with high purity can be obtained.

In order to achieve the above-mentioned object of the present invention, the present invention provides a method for manufacturing a non-oriented electrical steel plate, comprising the following steps:
(1) smelting and casting to obtain a continuous casting slab;
(2) heating and rolling to obtain a hot-rolled steel plate, wherein when the continuous casting slab is heated in a heating furnace and a temperature is raised to 1020° C. or more, a heating rate is controlled to be 0.8˜2.0° C./min; and a soaking time of the continuous casting slab in the heating furnace, that is, a time of the continuous casting slab in the heating furnace is controlled to be 0.10-0.25h;
(3) pickling the hot-rolled steel plate;
(4) cold-rolling the hot-rolled steel plate;
(5) continuous annealing to obtain a finished steel plate;
(6) coating a surface of the finished steel plate.

In the present invention, the inventors optimize the design of the steel's chemical composition and defines a reasonable manufacturing process. After a continuous casting slab is obtained through smelting and casting, by optimizing the heating and temperature rising process during hot rolling for the continuous casting slab and combining with the subsequent pickling, cold rolling, continuous annealing and coating process, a high-purity non-oriented electrical steel plate with nitride inclusions being low in content and large in size can be effectively prepared. The high-purity non-oriented electrical steel plate has the characteristics such as simplicity, being easy to control, good stability, low cost and wide application.

In the above heating and rolling of step (2) according to the present invention, the continuous casting slab is heated in a heating furnace, when the temperature is rised to 1020° C. or more, the heating rate is required to be limited to 0.8˜2.0° C./min. Herein, the main consideration is that when the heating rate is lower than 0.8° C./min, the solid solution amount of AlN inclusions and Cr₂N inclusions will increase significantly; accordingly, during the subsequent finish rolling and coiling process, as the temperature of the steel plate decreases, AlN and Cr₂N inclusions will precipitate again, in this case, the size of the precipitated inclusions is small, the number of the precipitated inclusions increases significantly, thus the purity of the steel is significantly reduced. Correspondingly, when the temperature rises to 1020° C. or more, if the heating rate is controlled to be higher than 2.0° C./min, the solid solution amount of AlN inclusions and Cr₂N inclusions reduces significantly. In this case, the fine AlN inclusions, especially Cr₂N inclusions, precipitated at the end of solidification in casting of molten steel cannot be fully dissolved and still exist in a single form, and a small size, which harms the recrystallization and the formation of favorable texture of the hot-rolled microstructure. Therefore, in order to promote its effective growth and avoid hazards as much as possible, it is necessary to ensure that the soaking time of the continuous casting slab/the time of the continuous casting slab in the furnace during the hot rolling process is limited to 0.10 to 0.25 h.

In the limited range, under long-term and high temperature conditions, it is beneficial for AlN and Cr₂N inclusions to grow and coarsen, and some nitride inclusions are mainly single Cr₂N and/or AlN composite inclusions encapsulated with Cr₂N, so the quantity of AlN and Cr₂N inclusions is greatly reduced, thereby it can be ensured that nitride inclusions with a size of 0.2 to 1.0 μm can account for 50 volume % or more of all nitride inclusions, and the quantity of nitride inclusions in the final steel plate is ≤2.5×10⁷/mm³.

It should be noted that when the soaking time of the continuous casting slab/the time of the continuous casting slab in the furnace is less than 0.1h, the AlN and Cr₂N inclusions in the steel cannot effectively grow and coarsen; when the time is more than 0.25h, the solid solution content of AlN and Cr₂N inclusions increase significantly, which leads to a significant increase in AlN inclusion precipitation in the steel during the subsequent finish rolling and coiling processes, the nitride inclusions with a size of 0.2 to 1.0 μm fails to reach 50 volume % or more of all nitride inclusions, and the quantity of nitride inclusions in the steel plate greatly exceeds 2.5×10⁷/mm³.

Compared with the prior art, the non-oriented electrical steel plate and the manufacturing method thereof according to the present invention has the following advantages and beneficial effects:

In the non-oriented electrical steel plate according to the present invention, the inventors optimize the chemical element composition ratio and the related manufacturing process. After a continuous casting slab is obtained through smelting and casting, by optimizing the parameters of the heating and temperature rising process of the continuous casting slab during hot rolling, and combining with subsequent pickling, cold rolling, continuous annealing and coating processes, a high-purity non-oriented electrical steel plate with a low nitride inclusion content and a large size can be prepared effectively, thereby obtaining the electromagnetic properties required by the design of the present invention.

The design concept of the chemical element of the present invention is completely different from the prior art. It has the characteristics such as being simple and easy to control, good stability, low cost, and wide application, and the inclusions in steel can be effectively controlled. The prepared non-oriented electrical steel plate has high purity and has good promotion prospects and application value.

### BRIEF DESCRIPTION OF THE DRAWINGS

FIG. 1 schematically shows the relationship between Al/Cr and nitride inclusions in the non-oriented electrical steel plate according to the present invention.

FIG. 2 schematically shows the relationship between the soaking time/time in furnace and the control effect of inclusions in the non-oriented electrical steel plate according to the present invention.

FIG. 3 is a microstructure photograph of the non-oriented electrical steel plate of example 6.

FIG. 4 is a microstructure photograph of the comparative steel of comparative example 2.

### DETAILED DESCRIPTION

The non-oriented electrical steel plate and the manufacturing method therefor according to the present invention will be further explained and illustrated below with reference to drawings of the description and specific examples. However, the explanations and illustrations do not constitute an unduelimitation on the technical solutions of the present invention.

### Examples 1-7 and Comparative Examples 1-3

Table 1 lists the mass percentages of the chemical elements in the non-oriented electrical steel plates of examples 1-7 and the comparative steel plates of comparative examples 1-3.

TABLE 1
(The balance is Fe and inevitable impurities other than P, S, O, and N)

| | Chemical elements | | | | | | | | | |
|---|---|---|---|---|---|---|---|---|---|---|
| | C | Si | Mn | P | S | Al | Cr | O | N | |
| Number | (wt %) | (wt %) | (wt %) | (wt %) | (wt %) | (wt %) | (wt %) | (wt %) | (wt %) | Al/Cr |
| Example1 | 0.0008 | 0.08 | 1.98 | 0.02 | 0.0018 | 0.11 | 0.009 | 0.0011 | 0.0011 | 12.2 |
| Example2 | 0.0032 | 0.27 | 0.97 | 0.02 | 0.0050 | 0.47 | 0.006 | 0.0021 | 0.0028 | 78.3 |
| Example3 | 0.0089 | 0.99 | 1.25 | 0.13 | 0.0027 | 0.98 | 0.02 | 0.0010 | 0.0048 | 49.0 |
| Example4 | 0.0041 | 1.32 | 0.23 | 0.09 | 0.0038 | 1.35 | 0.05 | 0.0017 | 0.0032 | 27.0 |
| Example5 | 0.0062 | 2.04 | 1.56 | 0.10 | 0.0019 | 1.67 | 0.12 | 0.0022 | 0.0027 | 13.9 |
| Example6 | 0.0098 | 3.28 | 0.06 | 0.05 | 0.0037 | 2 | 0.2 | 0.0010 | 0.0009 | 10.0 |
| Example7 | 0.0021 | 4.44 | 0.48 | 0.02 | 0.0044 | 1.73 | 0.08 | 0.0007 | 0.0018 | 21.6 |
| Comparative | 0.0047 | 0.17 | 0.18 | 0.10 | 0.0013 | 0.13 | 0.02 | 0.0017 | 0.0055 | 6.5 |
| example1 | | | | | | | | | | |
| Comparative | 0.0021 | 2.32 | 2.22 | 0.05 | 0.0039 | 0.83 | 0.005 | 0.0021 | 0.0037 | 166.0 |
| example2 | | | | | | | | | | |
| Comparative | 0.0092 | 5.45 | 0.89 | 0.04 | 0.0022 | 1.94 | 0.1 | 0.0009 | 0.0018 | 19.4 |
| example3 | | | | | | | | | | |

The non-oriented electrical steel plates of examples 1-7 and the comparative steel plates of comparative example 1-3 are prepared by the following steps:

(1) Smelting and casting with the chemical composition ratio shown in Table 1: during the smelting process, the design of the steel's chemical composition is adjusted according to the design requirements of the present invention to ensure a specific relationship between Al and Cr, thereby obtaining molten steel that meets the design requirements of chemical composition. The molten steel is then cast and solidified into a continuous casting slab according to the specified size.

(2) Heating and rolling: the obtained continuous casting slab is input into a heating furnace for heating and temperature rising. During this period, the heating rate of the continuous casting slab is adjusted in stages according to the design requirements. When the temperature rises to 1020° C. or more, the heating rate is controlled to be 0.8˜2.0° C./min. The soaking time of the continuous casting slab in the heating furnace/the time of the continuous casting slab in the furnace is controlled to be 0.10˜0.25h.

(3) Pickling: removing the iron oxide scale from the surface of hot-rolled steel plates using HCl turbulent picking.

(4) Cold rolling: rolling to the target thickness of the steel plate at one time using a continuous rolling mill or a reciprocating rolling mill.

(5) Continuous annealing: controlling the annealing temperature to be 650˜1050° C., the annealing time to be ≤180s, and the annealing atmosphere to be a mixture of H₂ and N₂, wherein the volume ratio of H₂ is 20%˜60%.

(6) Coating: coating a semi-organic insulating coating on the surface of the finished steel plate.

It should be noted that, in the present invention, the chemical compositions and related process parameters of examples 1-7 all meet the control requirements of the design specification of the present invention. The comparative steels of comparative examples 1-3 are also prepared by the above process steps, but there are parameters that do not meet the design requirements of the present invention in their chemical element composition and/or related process parameters.

Table 2 lists the specific process parameters of the non-oriented electrical steel plates of examples 1-7 and the comparative steel plates of comparative examples 1-3 in the above manufacturing process flow.

TABLE 2

| | Step (2) | Step (5) |
|---|---|---|
| | Heating rate when the | Soaking time/time |
| | temperature rises to 1020° C. | in furnace |
| Number | or more (° C./min) | (h) |
| Example1 | 0.8 | 0.20 |
| Example2 | 1.0 | 0.12 |
| Example3 | 1.6 | 0.14 |
| Example4 | 1.2 | 0.17 |
| Example5 | 2.0 | 0.25 |
| Example6 | 1.4 | 0.20 |
| Example7 | 1.8 | 0.10 |
| Comparative | 0.2 | 0.09 |
| example1 | | |
| Comparative | 0.9 | 0.35 |
| example2 | | |
| Comparative | 2.2 | 0.18 |
| example3 | | |

The finished non-oriented electrical steel plates of examples 1-7 and comparative steel plates of comparative examples 1-3 finally obtained are sampled respectively, and the steel samples of examples 1-7 and comparative examples 1-3 are observed and analyzed. It is found that the steels of each example and comparative example contain a variety of inclusion components, and the main inclusions are nitrogen-containing inclusions. Through further analysis and testing, the quantity of nitride inclusions and the composition and proportion of each nitride inclusion in the steel plate samples of examples 1-7 and comparative examples 1-3 can be obtained respectively. The relevant results of observation and analysis are listed in the following Table 3.

Table 3 lists the detection results of inclusions of the non-oriented electrical steel plates of examples 1-7 and the comparative steel plates of comparative example 1-3.

TABLE 3

| | Quantity of | Quantity of | | The proportion of nitride | Quantity of |
|---|---|---|---|---|---|
| | AlN | Cr₂N | | inclusions of 0.2~1.0 μm | nitride |
| | inclusions | number | [AlN]/([AlN] + | to all nitride inclusions | inclusions |
| Number | (×10⁷/mm³) | (×10⁷/mm³) | [Cr₂N]) | (Volume %) | (×10⁷/mm³) |
| Example1 | 2.41 | 0.02 | 0.99 | 54 | 2.43 |
| Example2 | 1.54 | 0.11 | 0.93 | 81 | 1.65 |
| Example3 | 0.52 | 0.06 | 0.90 | 67 | 0.58 |
| Example4 | 2.17 | 0.31 | 0.88 | 91 | 2.48 |
| Example5 | 1.33 | 0.22 | 0.86 | 56 | 1.55 |
| Example6 | 0.76 | 0.17 | 0.82 | 63 | 0.93 |
| Example7 | 2.14 | 0.1 | 0.95 | 77 | 2.25 |
| Comparative | 2.49 | 0.51 | 0.83 | 42 | 3.00 |
| example1 | | | | | |
| Comparative | 3.24 | 1.71 | 0.65 | 82 | 4.95 |
| example2 | | | | | |
| Comparative | 3.83 | 0.29 | 0.93 | 23 | 4.12 |
| example3 | | | | | |

Note:
In the above Table 3, AlN and Cr₂N represent their corresponding volume percentage of nitride inclusions.

When observing the inclusions of the steel plates of various examples and comparative examples, the researchers find that in the non-oriented electrical steel plates of examples 1-7 prepared in the present invention, the nitride inclusions in the steel are mainly single Cr₂N and/or AlN composite inclusions encapsulated with Cr₂N.

Afterwards, the inclusions in the samples of steel plates are detected and analyzed, the quantity and particle size of each nitride inclusion were counted, and the volume percentage of nitride inclusions with a particle size of 0.2˜1.0 μm is calculated as follows:

The statistic is performed using non-aqueous solution electrolytic extraction and scanning electron microscopy observation. For each sample, the electrolysis amount is 0.1 g, the pore size of the filter membrane is 20 nm, and the observed field of view is not less than 0.40 mm².

After detecting the inclusions of the samples of steel plates of each example and comparative example, it is found that in the non-oriented electrical steel plates of examples 1-7, the quantity of AlN inclusions is 0.52-2.41×10⁷/mm³, the quantity of Cr₂N inclusions is 0.02-0.31×10⁷/mm³, 0.82 [AlN]/([AlN]+ [Cr₂N])≤0.99, and the proportion of nitride inclusions with a size of 0.2 to 1.0 μm to all nitride inclusions is 54-91 volume %, and the quantity of nitride inclusions is 0.58-2.48×10⁷/mm³.

However, in comparative example 1, Al and Cr elements are not added according to the requirement of the present invention, and the Al/Cr ratio is 6.5, which is lower than the lower limit of 10 of the design requirement of the present invention; In addition, the heating rate of comparative example 1 is only 0.2° C./min when at 1020° C. or more, which is lower than the lower limit of 0.8° C./min of the design requirement of the present invention. Therefore, the nitride inclusions of 0.2˜1.0 μm in the comparative steel plate of comparative example 1 finally prepared account for only 42% by volume of all nitride inclusions, and the quantity of small-sized AlN and Cr₂N inclusions in the steel is large, ultimately leading to a total amount of nitride inclusions in the steel being as high as 3.0×10⁷/mm³. It fails to achieve the effect of the design of the present invention.

In comparative example 2, Al and Cr elements are not added according to the requirement of the present invention, and the Al/Cr ratio is as high as 166, which is higher than the upper limit of 80 of the design requirement of the present invention; In addition, the soaking time of the continuous casting slab in the heating furnace/the time of the continuous casting slab in the furnace of comparative example 2 is 0.35, resulting in a ratio of [AlN]/([AlN]+ [Cr₂N]) being only 0.65, which does not meet the lower limit of 0.80 as required by the design of the present invention. The quantity of fine Cr₂N inclusions in the corresponding steel is as high as 1.71×10⁷/mm³, thereby resulting in a total amount of nitride inclusions in the steel being as high as 4.95×10⁷/mm³, which fails to achieve the effect of the design of the present invention.

In comparative example 3, when the continuous casting slab of comparative example 3 is in the heating furnace, the heating rate is as high as 2.2° C./min when being at 1020° C. or more, which is higher than the upper limit of 2.0° C./min required by the design of the present invention. As a result, the small-sized AlN and Cr₂N generated during the solidification in casting of the molten steel cannot effectively grow or precipitate in advance after solid solution during the hot rolling heating process due to the high temperature and short time. Therefore, the nitride inclusions of 0.2˜1.0 μm of the comparative steel plate of comparative example 3 account for only 23% of all nitride inclusions by volume, the quantity of small-sized AlN inclusions is as high as 3.83×10⁷/mm³. Finally, the total amount of nitride inclusions in the steel is as high as 4.12×10⁷/mm³, which fails to achieve the effect of the design of the present invention. In summary, it can be seen that the design concept of the chemical elements of examples 1-7 designed by the present invention is completely different from the prior art, and it has the characteristics of being simple and easy to control, good stability, low cost, and wide application, and can effectively control the inclusions in steel. The prepared non-oriented electrical steel plate has a very high purity, and has good promotion prospects and application value.

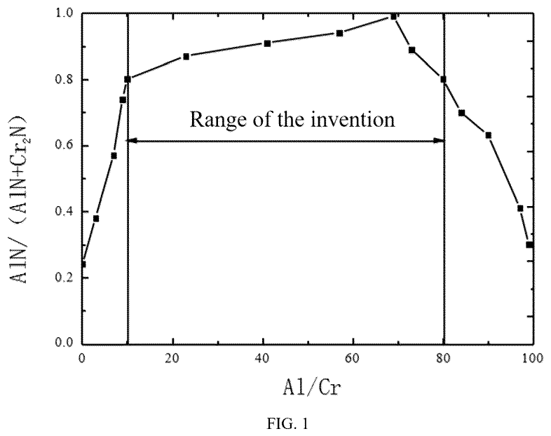

FIG. 1 schematically shows the relationship between Al/Cr and nitride inclusions in the non-oriented electrical steel plate according to the present invention.

As shown in FIG. 1, in the steel in the present invention, as Al/Cr increases, AlN/(AlN+Cr₂N) first increases rapidly, I and when Al/Cr reaches 10%, AlN/(AlN+Cr₂N): reaches 0.80; Afterwards, as Al/Cr continues to increase, AlN/(AlN+Cr₂N) increases slowly to a maximum value, and then begins to gradually decrease rapidly, and after Al/Cr reaches 80%, AlN/(AlN+Cr₂N) reaches 0.80 or less again, which fails to meet the design requirements according to the present invention.

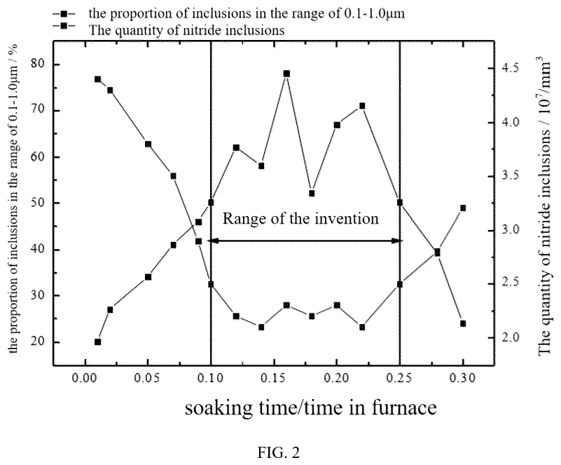

FIG. 2 schematically shows the relationship between the soaking time/time in furnace and the control effect of inclusions in the non-oriented electrical steel plate of the present invention.

As shown in FIG. 2, in the specific hot rolling process in the present invention, when the continuous casting slab is heated in a heating furnace, the soaking time/time in furnace must be controlled within a suitable range, i.e., 0.10-0.25h. When the soaking time/time in furnace is less than 0.1h, the proportion of nitride inclusions of 0.2-1.0 μm to all nitride inclusions is less than 50% or less by volume, and the quantity of nitride inclusions in the final steel plate is greater than 2.5×10⁷/mm³. The proportion of inclusions of 0.1-1.0 μm to all nitride inclusions and the quantity of nitride inclusions show an increasing or decreasing trend respectively with the increase of soaking time/time in furnace. When the soaking time/time in furnace is higher than 0.25h, the quantity of nitride inclusions in the final steel plate gradually increases again and exceed the design requirement of 2.5×10⁷/mm³, at the same time, the quantity of nitride inclusions of 0.2-1.0 μm decreases, leading to that the proportion of nitride inclusions of 0.2-1.0 μm to all nitride inclusions decreases to 50 volume % or less.

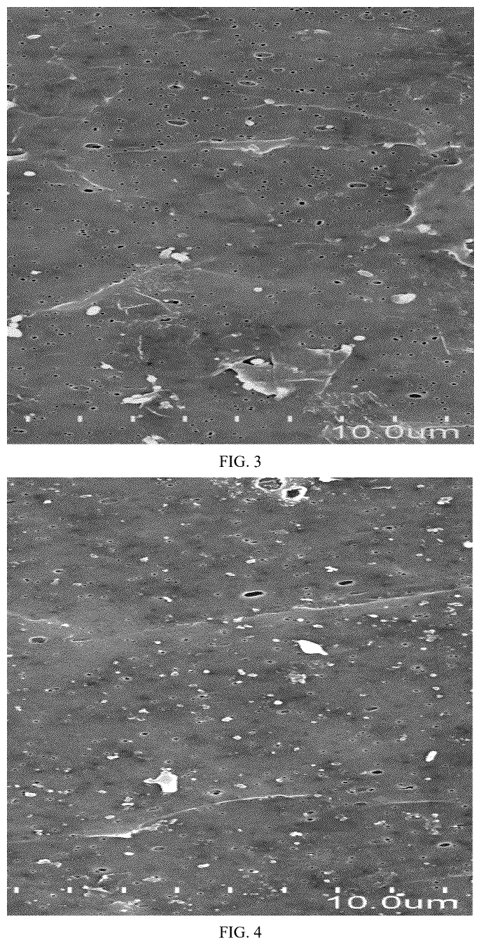

FIG. 3 is a microstructure photograph of the non-oriented electrical steel plate of example 6.

As shown in FIG. 3, In the typical microstructure photograph of the non-oriented electrical steel plate of example 6, the quantity of inclusions mainly composed of AlN is very small, and the average size of the two types of inclusions is relatively large. The statistical results show that in example 6, the proportion of nitride inclusions in the range of 0.2-1.0 μm accounts for 63% by volume of all nitride inclusions, and the quantity of nitride inclusions in the final steel plate is greater than 0.93×10⁷/mm³. FIG. 4 is a microstructure photograph of the comparative steel of comparative example 2.

As shown in FIG. 4, in the typical microstructure photograph of the comparative steel of comparative example 2, there are a large quantity of inclusions mainly compose of AlN, and the average size of both types of inclusions are very small. The statistical results show that in comparative example 2, although the proportion of nitride inclusions in the range of 0.2-1.0 μm accounts for 82 volume % of all nitride inclusions, the quantity of nitride inclusions in the final steel plate is greater than 4.95×10⁷/mm³. It should be noted that the prior art part in the protection scope of the present invention is not limited to the embodiments provided in the present application. All prior arts that do not contradict the solution of the present invention, including but not limited to prior patents, prior publications, prior public uses, etc., can all be included in the protection scope of the present invention.

In addition, the combination manners of technical features in the present invention are not limited to the combination manners described in the claims the specific embodiments of the present invention, and all the technical features described in the present invention can be freely combined or incorporated in any manners unless contradicted by each other.

It should be further noted that the embodiments listed as above are merely specific examples of the present invention. Obviously, the present invention is not limited to the above-mentioned embodiments, similar variations or modifications made therewith is obvious for those skilled in the art or can be directly obtained from the disclosure of the present invention by those skilled in the art, all of which fall within the protection scope of the present invention.

1. A non-oriented electrical steel plate, wherein the non-oriented steel plate comprises, in addition to Fe and inevitable impurities, the following chemical elements in percentage by mass: 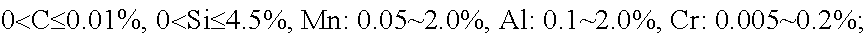
a mass percentage ratio of Al to Cr satisfies: 10≤Al/Cr≤80, preferably 13.9≤Al/Cr≤49.

2. The non-oriented electrical steel plate according to claim 1, wherein the steel comprises the following chemical elements in percentage by mass:
0<C≤0.01%, 0<Si≤4.5%, Mn: 0.05˜2.0%, Al: 0.1˜2.0%, Cr: 0.005˜0.2%; the balance being Fe and inevitable impurities;
the mass percentage ratio of Al to Cr satisfies: 10≤Al/Cr≤80, preferably 13.9≤Al/Cr≤49.

3. The non-oriented electrical steel plate according to claim 1, wherein, among the inevitable impurities, P≤0.2%, S≤0.005%, N≤0.005%, and 0≤0.005%.

4. The non-oriented electrical steel plate according to claim 1, wherein a content of Cr element is 0.01-0.12%.

5. The non-oriented electrical steel plate according to claim 1, wherein nitride inclusions in the steel include single Cr₂N and/or AlN composite inclusions encapsulated with Cr₂N.

6. The non-oriented electrical steel plate according to claim 5, wherein a volume ratio of the nitride inclusions AlN and Cr₂N satisfies: 0.80≤[AlN]/([AlN]+ [Cr₂N])≤0.99.

7. The non-oriented electrical steel plate according to claim 5, wherein a quantity of the nitride inclusions is ≤2.5×10⁷/mm³.

8. The non-oriented electrical steel plate according to claim 5, wherein, by volume percentage, nitride inclusions with a size of 0.2 to 1.0 μm account for 50% or more of all nitride inclusions.

9. A method for manufacturing the non-oriented electrical steel plate according to claim 1, comprising following steps:
(1) smelting and casting to obtain a continuous casting slab;
(2) heating and rolling to obtain a hot-rolled steel plate, wherein when the continuous casting slab is heated in a heating furnace and a temperature is raised to 1020° C. or more, a heating rate is controlled to be 0.8˜2.0° C./min; and a soaking time of the continuous casting slab in the heating furnace/a time of the continuous casting slab in the heating furnace is controlled to be 0.10-0.25h;
(3) pickling the hot-rolled steel plate;
(4) cold-rolling the hot-rolled steel plate to obtain a cold-rolled steel plate;
(5) continuous annealing the cold-rolled steel plate to obtain a finished steel plate;
(6) coating a surface of the finished steel plate.

10. The non-oriented electrical steel plate according to claim 2, wherein, among the inevitable impurities, P≤0.2%, S≤0.005%, N≤0.005%, and O≤0.005%.

11. The non-oriented electrical steel plate according to claim 2, wherein a content of Cr element is 0.01-0.12%.

12. The non-oriented electrical steel plate according to claim 2, wherein nitride inclusions in the steel include single Cr₂N and/or AlN composite inclusions encapsulated with Cr₂N.

13. The method according to claim 9, wherein the steel comprises the following chemical elements in percentage by mass:
0<C≤0.01%, 0<Si≤4.5%, Mn: 0.05˜2.0%, Al: 0.1˜2.0%, Cr: 0.005˜0.2%; the balance being Fe and inevitable impurities;
the mass percentage ratio of Al to Cr satisfies: 10≤Al/Cr≤80, preferably 13.9≤Al/Cr≤49.

14. The method according to claim 9, wherein, among the inevitable impurities, P≤0.2%, S≤0.005%, N≤0.005%, and O≤0.005%.

15. The method according to claim 9, wherein a content of Cr element is 0.01-0.12%.

16. The method according to claim 9, wherein nitride inclusions in the steel include single Cr₂N and/or AlN composite inclusions encapsulated with Cr₂N.

17. The method according to claim 16, wherein a volume ratio of the nitride inclusions AlN and Cr₂N satisfies: 0.80≤[AlN]/([AlN]+[Cr₂N])≤0.99.

18. The method according to claim 16, wherein a quantity of the nitride inclusions is ≤2.5×10⁷/mm³.

19. The method according to claim 16, wherein, by volume percentage, nitride inclusions with a size of 0.2 to 1.0 μm account for 50% or more of all nitride inclusions.
